(19) United States
(12) Patent Application Publication
(10) Pub. No.: US 2005/0258288 A1
(43) Pub. Date: Nov. 24, 2005

(54) High pressure media milling system and process of forming particles

(75) Inventors: Sean M. Dalziel, San Francisco, CA (US); Gary W. Foggin, Wilmington, DE (US); William N. Ford, Hockessin, DE (US); Henricus J. C. Gommeren, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(73) Assignee: E. I. du Pont de Nemours and Company

(21) Appl. No.: 10/998,103

(22) Filed: Nov. 26, 2004

Related U.S. Application Data
(60) Provisional application No. 60/525,395, filed on Nov. 26, 2003.

(51) Int. Cl. B02C 17/16

(52) U.S. Cl. 241/172

(57) ABSTRACT

The present invention relates to a media mill system and a method using the same to produce fine and ultra-fine particles useful in diagnostic agents, pharmaceuticals, agrochemicals, nutraceuticals and the like.

### FIELD OF THE INVENTION

This invention relates to a high pressure media mill system, apparatus and a method of using the same to produce fine and ultra-fine particles that are particularly useful in the agricultural, pharmaceutical, nutraceutical, chemical, and diagnostic fields.

### BACKGROUND OF THE INVENTION

Milling, grinding, and crushing, as currently practiced within the art are susceptible to several problems including contamination of the product, degradation of heat sensitive materials during grinding, toughness of some solids (e.g., most polymers, proteins, polysaccharides, etc), chemical degradation due to exposure to the atmosphere, long processing times and high energy consumption.

In the pharmaceutical, agricultural and other industries, media milling is a frequently used method for the production of fine and ultra-fine (nano) particle sizes. The media milling process typically involves charging grinding media to the milling chamber together with the material to be ground. In the case of wet media milling, typically the material to be ground is added to the mill as a slurry comprised of a solid suspended in a liquid. Often, a surfactant is added to stabilize the slurry. A stirring device of some form can then be used to agitate the grinding media, thereby causing the solid particles to be ground. Alternatively, the grinding media can be set into motion by either applying planetary, tumbling or vibratory motion to the milling chamber, or subjecting magnetic grinding media that has been charged to the milling chamber to an alternating/fluctuating magnetic field. Typical wet mills include colloid mills, pressure homogenizers, rotor stators, and media mills. See, for example, “Technical Aspects of Dispersion”, by D. A. Wheeler, Chapter 7, “Dispersion of Powders in Liquids”, edited by G. D. Parfitt, 3^{rd} Edition, Applied Science Publishers hereby incorporated by reference.

Examples of media mills typically found within the art include those described in U.S. Pat. No. 6,056,791 (Weidner); U.S. Pat. No. 5,854,311; U.S. Pat. No. 5,500,331; U.S. Pat. No. 5,145,684; U.S. Pat. No. 5,518,187 (Bruno, et al); U.S. Pat. No. 5,862,999 (Czekai, et al.); U.S. patent application No. 2002/0003179 A11 (Verhoff, et al.) and U.S. Pat. No. 5,145,684, (Liversidge et al.) and EPO 498,492.

In the pharmaceutical and agricultural fields, high bioavailability and short dissolution times are desirable, and often necessary, attributes of the end products produced. A large proportion of small molecule bioactives are poorly soluble in water or gastric fluids. Thus, to increase dissolution rate and bioavailability, the particle size is reduced so as to increase the surface area. Thus, successful production of small particles may result in the end products having shorter dissolution times, increased bioavailability and potentially faster onset of bioactivity.

The use of supercritical fluids in processing technology is known in the art. Typically, the most widely utilized supercritical fluid for industrial (i.e. pharmaceutical, agricultural, etc.) applications is carbon dioxide, however, other hydrocarbon gases such as, ethane, propane, butane and ethylene, water, nitrous oxide ammonia and trifluoromethane have been utilized. Supercritical fluids allow for improved recovery, increased reproducibility, decrease the need to use halogenated solvents, reduce contamination, yield a concentrated sample that is easily manipulated, and preserve the chemical integrity of the milled product. Moreover, the use of supercritical fluids allows for the processing capabilities associated with wet processes while also having the advantage of providing a dry product. The use of supercritical fluids in processing technology can be found in U.S. Pat. No. 5,108,109 and Hock S. Tan and Suresh Borsadia, Particle Formation Using Supercritical Fluids: Pharmaceutical Applications, Exp. Opin. Ther. Patents (2001) 11(5), Asley Publications Ltd.

Several processes utilizing supercritical fluids have been described in the art, for example, the rapid expansion of supercritical solutions process (RESS), and a process using antisolvents (SAS), however each process is also problematic.

In the RESS process, a solute substance is contained in a high-pressure vessel, where a supercritical fluid is charged to the vessel to dissolve the solute and form a solution of the substance in the supercritical fluid. The fluid mixture is then expanded through a nozzle into a vessel held at a substantially lower sub-critical pressure where the fluid is a low density gas. As a result of the low solvent power of the low-pressure gas, the substance precipitates and is collected. The rapid expansion causes a rapid change in the density and solvent power of the fluid and therefore rapid crystallization rates resulting in the formation of microparticles and nanoparticles of the solute substance. However, many drug compounds have a low level of solubility in supercritical fluids, particularly carbon dioxide. The solubility difficulties are burdensome in trying to form microparticles or nanoparticles and thus limit the RESS process. With respect to an antisolvent process, it requires the use of a soluble solvent suitable for use with the particular compound.

It would, therefore, be advantageous to prepare fine and ultra-fine particles (around 10 μm or less), especially in the sub-micron and nano-size range, having consistent and controlled physical criteria, including particle size, quality of the crystalline phase, chemical purity, retained chemical integrity and solid state properties and enhanced handling and fluidizing properties. In particular, the pharmaceutical and agricultural fields have a pronounced need for an apparatus and/or method capable of large-scale production of sub-micron and nano-sized particles having the above-noted qualities. The present invention is advantageous because it has a high degree of grinding efficiency, which prevents or lessens the build-up of heat within the grinding chamber that could potentially change the morphology of the particles.

### SUMMARY OF THE INVENTION

The embodiments of the present invention allow for the direct and substantially immediate production of acceptable fine and ultra-fine particles that exhibit greatly reduced particle size and increased surface area, purity and uniformity (i.e., well-mixed). The high surface area (typically ranging from about 1 m²/gram to about 50 m²/gram) generating by grinding may enable poorly water soluble bioactive particles to meet the bioavailability needs of a wide range of industries. The embodiments of the present invention, therefore, provide a finer product than can be produced using existing technology as well as a more efficient way to produce acceptable dry, fine and ultra-fine sized particles for several industry segments; including particularly the pharmaceutical and agricultural industries.

The embodiments of the apparatus of the present invention relate to a high pressure milling system, as well as the high pressure media mill itself, the system comprising:
(a) a pressure delivery device;
(b) a media mill fluidly connected to said pressure delivery device comprising a housing defining a grinding chamber; an agitator contained within said grinding chamber, a motor in rotation communication with the agitator, and an amount of grinding media contained within the grinding chamber; and
(c) a means for product collection/separation fluidly connected to said media mill.

The high pressure media mill system as described above includes further components wherein the housing has a top, a body, a floor, preferably at least one discharge port, preferably at least one charging port, and an optional retention screen, wherein the discharge port is plugged with a removable plunger.

The present invention also relates to embodiments of a process for milling a substance under high pressure comprising:
(i) evacuating the milling system according to claim 1 to produce a vacuum;
(ii) charging the media mill with an amount of grinding media, a product and/or a fluid and/or a co-solvent;
(iii) pressurizing the media mill system with the fluid;
(iv) operating the media mill to reduce the particle size of the product; and
(v) separating the product from the fluid.

Step (ii) of the embodiments of the above-described process may further include a co-milling or co-grinding or co-processing aspect (including in-process formulation and dispersion as well as encapsulation or coating/surface modification of product), where in addition to the product and fluid, additives such as inactive ingredients may also be charged to the grinding chamber. Thus, the embodiments of the process allow for in-process formulation and dispersion as well as encapsulation or coating of various types of particles, such that the particles are stabilized and compatible with other downstream applications for the final product composition.

The embodiments of the present invention combine a media mill and the use of a supercritical fluid, volatile gas (e.g., hydrofluorocarbon gases) wherein such gases are not in a supercritical state, or liquefied gases as a milling medium to produce fine and ultra-fine particles in a dry powder form without a limitation of solubility and without the requirement of organic solvents or high temperatures. The process embodiments have applications for use with a broad range of materials including heat sensitive bioactive materials and environmental sensitive electronic materials.

The production of fine and ultra-fine particles is used in many applications. Potential applications of this technology are very broad, for example, industries able to utilize the particles generated by the present invention include oral, transdermal, injected or inhaled pharmaceuticals, biopharmaceuticals, nutraceuticals, diagnostic agents, agrochemicals, agricultural products, pigments, food ingredients, food formulations, beverages, chemicals, cosmetics, electronic materials, inks, paints, micro-organisms, inorganic minerals and metals.

The embodiments of the present invention are advantageous in providing a system that allows for safer and more efficient product collection, thereby resulting in less contamination, a higher yield of product due to its collection devices; and less product loss during use and collection. In addition the embodiments of the present invention provide a more efficient process for the production of particles in that it may be a batch, continuous or semi-continuous process (or flush through process) versus the current batch systems.

### BRIEF DESCRIPTION OF THE FIGURES

FIG. 1 depicts a cross sectional side view of an embodiment of the high pressure media mill according to the present invention.

FIG. 2 depicts a cross sectional side view of an embodiment of the plunger, including a retention screen.

FIG. 3 depicts a side view of a bottom portion of an embodiment of an agitator according to the present invention.

FIG. 4 depicts a general schematic of an embodiment of the overall system according to the present invention.

FIG. 5 depicts a general schematic of an embodiment of the product collection wherein a pressurized filter is used.

FIG. 6 depicts a general schematic of an embodiment of the present invention for the flash collection of product, wherein the mill contents are sprayed into the collection filter housing.

FIG. 7A: depicts a SEM of milled lactose particles showing a sub-micron granular structure.

FIG. 7B: also depicts a SEM of milled lactose particles showing a sub-micron granular structure.

FIG. 8 depicts a dissolution profile of phenytoin samples using a dissolution bath.

### DETAILED DESCRIPTION OF THE INVENTION

All documents cited in this disclosure are specifically incorporated by reference in their entirety. The invention can be practiced in accordance with the high pressure media milling process described in commonly owned, PCT Published Application WO 02/094443 claiming priority to U.S. Provisional Patent Application Ser. No. 60/292,798 filed May 23, 2001, entitled “High Pressure Media Milling”, attorney docket number CL-1728, and U.S. Provisional Patent Application Ser. No. 60/427,122, attorney docket number FL-1082 filed Nov. 18, 2002, now a copending nonprovisional application filed Nov. 7, 2003 titled “Media Milling Using Nonspherial Grinding Media”; the disclosures of which are hereby incorporated by reference.

Where a range of numerical values is recited herein, unless otherwise stated, the range is intended to include the endpoints thereof, and all integers and fractions within the range. It is not intended that the scope of the invention be limited to the specific values recited when defining a range. Moreover, all ranges set forth herein are intended to include not only the particular ranges specifically described, but also any combination of values therein, including the minimum and maximum values recited.

The embodiments of the present invention may be utilized for the milling and dispersion of any particles (i.e. crystals, amorphous materials, etc.), including pharmaceuticals (including those for use in humans as well as those for veterinary purposes), biopharmaceuticals, nutraceuticals, diagnostic agents, agrochemicals, pigments, food ingredients, food formulations, beverages, fine chemicals, cosmetics, electronic materials, inorganic minerals and metals; however for ease of description, principally pharmaceuticals and agrochemicals will be specifically addressed. The particles for other industry segments can be produced using the same general techniques described herein as easily modified by those skilled in the art.

The embodiments of the present invention contemplate a system comprising a scaleable media milling apparatus (1), system (22) and process using said apparatus (1) to produce fine particles (≦10 micron) or ultra-fine particles (sub-micron and nano-sized), determined using laser diffraction methods. The material passes through the apparatus (1) in a batch, continuous or semi-continuous fashion (or flush-through process). Spherical or nonspherical shaped grinding media (21) may be used to produce small particles useful in many commercial applications including particularly pharmaceuticals, nutraceuticals, agricultural and diagnostic agents.

The embodiments of the present invention further contemplate an optional recirculation system utilized during a semi-continuous or continuous process, wherein the particles may be redirected to the media mill for further grinding, however a batch process is also contemplated, wherein the necessary adjustment to result in such a process would be known to one skilled in the art.

Generally, the embodiments of the present invention can be produced in lab-scale sizes (e.g., 300 mL and 1000 mL volumes), with scale-up to larger volumes (e.g., 40-plus Liter volume or scale-up factors up to at least one hundred times, i.e. 5000 liters) capable of being accomplished. The size of the apparatus is limited only by good engineering practices, for example issues such as scaling and associated tip speed and power density as set forth in Wet comminution in stirred media mills—research and its practical application; Kwade, Arno; Powder Technology 105 (1999) 14-20; Elsevier. Scaling of the present invention to various sizes does not occur on a linear scale, however, such adjustments necessary to result in an appropriate apparatus within the scope of this invention would be recognized and known to those skilled in the art.

As used herein, a “media mill apparatus” or “media milling process” includes the preferred embodiment disclosed herein, as well as the alternative embodiments, such as those utilizing various agitator embodiments, pressure delivery devices, product collection devices and the like. A media mill apparatus, or media milling process, generally describes any device or method that achieves reduction in the size of solid particulate materials through a grinding process utilizing grinding media.

As used herein, “poorly soluble”, means that a pharmaceutical, nutraceutical, agricultural or diagnostic agent has a solubility in the fluid dispersion medium, e.g., carbon dioxide, of less than about 10 mg/ml, and preferably less than about 1 mg/ml. However, compounds that are not poorly soluble can still be milled by utilizing a fluid that is saturated with the compound.

As used herein, the term “fluid” in the context of milling means that the continuous phase may be a gas, a pressurized gas, a liquefied gas, a supercritical fluid, a subcritical fluid, or any combination thereof.

As used herein, the term “bioactive” refers to having an effect upon a living organism, tissue or cell.

As used herein, the term “product ” is meant to refer to particulate materials or other substances that may be milled or subjected to the forces within a media mill, a non-limiting example of which is a dry powder. Furthermore, the term is meant to describe a single type of product as well as a combination of product types (i.e. pharmaceutical, agrochemical, nutraceutical or diagnostic agent co-milled with other particle types such as inactive agent like excipients etc.).

Generally, the media mill may be charged with the grinding media, product and fluid separately, and the grinding media and product are introduced at ambient pressures using funnels but are not required to be charged in any particular order. Furthermore, the embodiments of the present invention also contemplate the use of a fluid to deliver the product to the grinding chamber as a pre-mix of product and fluid. Alternatively, if a recirculation system is utilized, a pre-mix of fluid and product may be introduced into the grinding chamber.

The fluid may be a pressurized gas such as pressurized nitrogen, a gas under supercritical pressure or temperature conditions such as CO₂ that is pressurized past its critical point or it may be a volatile gas. The volatile gas may also include those cooled to a liquid state, such as liquid CO₂. The supercritical fluid and the product are maintained under pressure, sufficient to prevent substantial volitalization or loss of the supercritical fluid.

A preferred embodiment of the high pressure media milling system (22) of the present invention comprises a pressure delivery device (17) fluidly connected to a high pressure media mill (1), which in turn, is fluidly connected to a means for product collection (16).

The system components, and accordingly the housing (2) and the other various components of the media mill (1), can be constructed of any generally non-reactive material having sufficient rigidity to withstand the pressures and forces created by use of the system and within the apparatus during its use, wherein these non-reactive materials include, but are not limited to, wear and corrosion resistant stainless steel (for example stainless steel designated as American Iron and Steel Institute 300 and 400 series) or liners for the interior of the media mill to reduce wear comprising materials such as ceramics, polymer PO, silicon carbide, Teflon® (available from E. I. du Pont de Nemours and Company, Wilmington, Del.) and the like. Preferably, for pharmaceutical and food-grade or food applications the materials utilized for the media mill and its components are acceptable materials for cGMP processing.

The high pressure media mill system may utilize a mill configuration such as, for example, an attritor, a tumbling ball mill, a vibratory ball mill, a planetary ball mill, a horizontal media mill, a vertical media mill, an annular media mill.

The pressure delivery device (17) may be any conventionally known device for maintaining the system (22) under pressure as well as during the flushing or cleaning of the system, provided such pressures are sufficient to prevent the formation of snow (i.e., a precipitate) in the system's lines during letdown resulting in blockage of the lines. The device (17) may be either manual or automatic, preferably the present invention utilizes a manual pressure control device. Moreover, the pressure delivery device (17) aids in the prevention of pressure swings within the grinding chamber (3), as well as controls of the flow rate of the fluid. For example the device (17) may be a bladder accumulator, a piston design or other conventional design known in the art. Examples of various pressure delivery devices (17) capable of being used with the present invention include bladder accumulators (e.g., Buna Bladder, 3000 psi:2.5 gal, carbon steel body, available from Parker Hannifin Corporation, Hydraulic Accumulator division, Rockford, Ill.); and piston designs such as, for example, pressure regulators (e.g., the 26-1700 Series available from Tescom, Industrial Controls Division, Elk River Minn.).

Generally, the high pressure media mill (1) is operable at pressures ranging from about atmospheric pressure to about 6000 psi depending on the temperature, however, the term “high pressure” is meant to describe a pressure ranging from about 30 psi to about 6000 psi, wherein the pressure is dependent upon the fluid utilized in the milling process. For example when a supercritical fluid is used, the mill preferably operates at about 1000-6000 psi, while if a liquefied gas is used the mill preferably operates between about 30 psi to about 6000 psi.

The flow rate of the fluid through the charging pipe may be controlled by any known method, non-limiting examples being a bladder, pump or pressure regulator (e.g., the 26-1700 Series available from Tescom, Industrial Controls Division, Elk River Minn.). Generally, those persons skilled in the art will recognize and understand those methods with which flow rates to typical milling devices may be restricted, such as including, but not limited to, using metering valves. Thus, those same methods are applicable to the present invention. The flow rate is limited only by the equipment used to control it.

Typically, the fluid connectivity between the pressure delivery device (17), media mill (1) and the product collection means (16) is provided by conduit, tubing or piping, preferably stainless steel piping. Such tubing or piping must be capable of withstanding the forces and pressures generated while the system (22) of the present invention is in use. Preferably, wear and corrosion resistant stainless steel (for example stainless steel designated as American Iron and Steel Institute 300 and 400 series) is utilized, wherein the steel has a mirror-like finish for use in pharmaceutical applications.

A preferred embodiment of the media mill (1) of the present invention comprises a housing (2) comprising a top (2a), a body (2b), a floor (2c) thereby defining a grinding chamber (3), and preferably, a second cavity (5). The top of the housing (12) is fastened to the body of the housing (2), although detachably connected for installation, cleaning and inspection purposes. The grinding chamber (3) should be able to accommodate an agitator (6) having at least one agitation element (7) comprising at least one pin, annulus or disc, an amount of grinding media, and the optional plunger (14) having the optional retention screen (13) or gap separator removeably attached thereto. The housing (2) further comprises a charging port (8); and preferably a discharge port (10). Additionally, the housing (2) is of a pressure tight design, such that a hermetic seal is formed to prevent the loss of any fluid or product. An example of a suitable vessel or housing is a 1 liter vessel and vessel top (e.g., part no. 94U42) available from Pressure Products Industries, Inc., located in Warminster, Pa.

As previously noted, the housing (2) defines a grinding chamber (3) and preferably a second cavity (5), wherein the preferred second cavity (5) allows for passage of a rotatably mounted drive shaft (11) through the top (2a) of the housing (2) to be connected with the agitator (6) and a motor (15). The grinding chamber (3) and second cavity (5) are separated from one another by a seal, which prevents any fluid contained in the grinding chamber from being released into the second cavity.

Preferably, at least two ports (a charging (8) and discharging port (10)) allow for the appropriate pipes to enter the media mill (1) for the charging and discharging of the product and/or grinding media (21) into the grinding chamber (3).

The charging (8) and discharging ports (10), and consequently the charging and discharging pipes, may be positioned anywhere on the housing (2), so long as the fluid is fed into the grinding chamber (3); for example, they may be positioned all on the same side of the housing (2), on opposite sides of the housing (2), on adjoining sides of the housing (2), or any combinations thereof. Preferably, however, the charging pipe deposits the fluid directly adjacent to and/or directly above the agitator (6). Moreover, the charging pipes may feed into the media mill (1) at any angle. Preferably, the discharging port (10) and pipe are in the floor (2c) of the housing (2).

The charging pipe assists in introducing the fluid into the grinding chamber (3) and may be of any diameter, as long as it is of a size to allow the necessary fluid flow rate. The number of pipes is limited only by the space available on the unit. The pipes may be utilized in numerous configurations including, for example, but not limited to, adjacent pipes, annularly positioned pipes, and the like. Plugs are inserted into the end of the pipe to prevent any of the milled product from re-entering the charging pipe, and thus, not being subject to the grinding media (21).

The preferred agitator (6) according to the present invention may comprise several configurations, wherein the agitator (6) may include, but is not limited to, at least one agitation element (7) such as, for example, at least one disc, pin or annulus extending radially away from the vertical axis of the agitator (6). The shape of the at least one pin is not critical for the present invention so long as the pin is capable of providing the requisite agitation and manipulation of the grinding media (21).

Alternatively, pins may also be integrated into the walls of the housing (2) such that a pin-counter-pin and disc configuration may be utilized.

The agitator may optionally further comprise at least one sweeper blade, which rotates with the agitator in order to prevent the plugging of the retention screen.

The agitator (6) is preferably connected to a rotatably mounted drive shaft (11). The drive shaft (11), in turn, is generally connected to a motor or drive unit (15) capable of rotating the agitator (6) at speeds sufficient to result in proper milling of the product. The drive shaft (11) is in connection with the motor (15) and preferably runs coaxially with the vertical axis of the agitator (6).

The agitator (6) eliminates the stagnant zones existing within the grinding chamber (3) because the force generated by the high circumferential speed of the agitation element (7) prevents the formation of such zones. The stagnant zones are problematic because the product to be ground could effectively avoid undergoing the requisite degree of grinding as it would not have been subjected to the grinding media (21) for an appropriate amount of time.

In addition, multiple agitators may be utilized wherein such an arrangement would further serve to increase the forces acting within the apparatus; and such variations of the apparatus are included within the scope of the claimed invention. For ease of description, only the preferred agitator embodiment is specifically addressed herein.

The agitator (6) of the present invention may also be interchangeable such that a variety of agitators may be used with a single housing embodiment, depending upon the application for which the grinding is performed. In general, the agitator (6) may be of any conventional design as set forth in Wet communition in stirred media mills—research and its practical application; Kwade, Arno, Power Technology 105 (1999) pgs. 14-20, Elselvier. The particles can be produced using the same general techniques described herein as easily modified by those skilled in the art.

In general, the motor (15) used to drive the agitator (6) may be any conventional motor known to those skilled in the art. The motor (15) is preferably situated outside of the housing (2), and particularly outside the grinding chamber (3), but is in rotational communication with the agitator. As noted earlier, one skilled in the art would recognize those adjustments necessary, to implement the use of a second cavity (5) and the necessary seals. Furthermore, the motor (15) may comprise motor/gear units, such that variable-speed gears allow for control of the rotation of the agitator. Alternatively, the motor (15) may be of an electric nature, and thus, allow for electronic speed control. Still further, the motor (15)/agitator (6) combination may utilize a magnetic drive (e.g., Model No. MM-120 belt driven Dyna/Mag mixer 316 SS available from available from Pressure Products Industries, Inc., located in Warminster, Pa., along with the use of magnetic media) or a direct mechanical drive. When a magnetic drive is utilized, the motor and agitator are still in rotational communication, even though a drive shaft may not be required.

The rotatably mounted drive shaft (11), which connects the motor to the agitator, may be a solid shaft, or conversely, may be hollow to allow it to act as a pipe to deposit the fluid within the grinding chamber (3).

The revolutions per minute (RPM) of the agitator (6) vary with the scale of the apparatus of the present invention. Generally, the maximum allowable RPM decreases as the apparatus (1) increases in size. Thus, the forces are more dependent upon tip speed rather than RPM's. Typically, the tip speed is up to about 25 meters per second, preferably between about 5 meters per second and about 25 meters per second, most preferably about 15 meters per second and generally remains in this range for apparatuses of differing sizes. For example, the appropriate tip speed for media mills of varying sizes may be calculated using the formula:

$$Tip speed = \frac{Π \times RPM * D ( mm )}{60 , 000}$$

The optional plunger (14) may be any device capable of accepting the optional retention screen (13) in a removable manner, while also being able to provide the appropriate pressure and fluid seal. Typically, the plunger (14) is removeable, such that it may be inserted into and removed from the discharge port (10) of the housing (2).

A preferred embodiment of the optional plunger (14) comprises a first cylindrical member having an first end and a second end; and a slidable second cylindrical member having an inner end comprising a plug upon which the retention screen may be removable mounted and an outer end. The second cylindrical member is nested within the first cylindrical member where the inner end is the portion inserted into the discharge port of the media mill. The second cylindrical member is capable of sliding along its major axis such that when the second cylindrical member is slid towards the grinding chamber, it effectively closes the discharge port thereby preventing product and/or fluid from escaping. Additionally, the second cylindrical member may be retracted (along with the optional retention (13) screen), thereby exposing a fluid/product flow path to allow for fluid communication with the remainder of the system. However, the retention screen (13) prevents grinding media (21) from exiting the grinding chamber (3).

As noted above, the retention screen (13) may be removably attached to the plunger (14), wherein it may be interchangeable to adapt to the type of grinding media (21) in use. An example of a suitable retention screen (13) is part no. W1548503 version A and B available from Swagelok.

The optional retention screen (13) may have variable mesh sizes, wherein the mesh size is dependent upon the size of the milling or grinding media (21) being used. The retention screen (13) allows for the passage of the product-containing fluid for that particular application, while retaining the grinding media (21) within the grinding chamber (3). Typically, mesh sizes may range widely depending upon the media utilized and the milled product, so long as the screen retains the grinding media. Preferably, the grit of the retention screen to be about ⅓ the size of the grinding media (21), more preferably about 440 micrometers.

Grinding media (21) is generally known to those of ordinary skill in the art and is generally comprised of any material of greater hardness and rigidity that the particulate matter to be ground. The grinding media (21) is generally selected from any variety of dense, tough, hard materials, such as, for example, nylon, polymeric or ceramic materials, sand, metals (e.g. stainless steal), zirconium silicate, zirconium oxide, yttrium oxide, glass, alumina, titanium, silica and the like. Preferably, the grinding media (21) is comprised of a tough resilient material having a low rate of attrition, and therefore a low incidence of contamination of the fine particles with attrited media pieces. Further, grinding media (21) may either consist entirely of a single material that is tough and resilient, or in the alternative, be comprised of more than one material, i.e., comprise a core portion having a coating of tough resilient material adhered thereon. Additionally, the grinding media (21) may be comprised of mixtures of any materials that are suitable for grinding. The polymeric resins suitable for use herein as grinding media (21) are chemically and physically inert, preferably substantially free of metals, solvents and monomers, and of sufficient hardness and friability to avoid being chipped and crushed during grinding. Suitable polymeric resins include, but are not limited to, crosslinked polystyrenes, such as polystyrene crosslinked with divinylbenzene, styrene copolymers, polycarbonates, polyacetals, such as Delrin®, vinyl chloride polymers and copolymers, polyurethanes, polyamides, poly(tetrafluoroethylenes), e.g., Teflon®, and other fluoropolymers, high density polyethylenes, polypropylenes, cellulose ethers and esters such as cellulose acetate, polyhydroxymethacrylate, polyhydroxyethyl acrylate, silicone containing polymers such as polysiloxanes and the like. Biodegradable polymeric resins are also suitable for use herein as grinding media (21). Exemplary biodegradable polymers include poly(lactides), poly(glycolide) copolymers of lactides and glycolide, polyanhydrides, poly(hydroxyethyl methacylate), poly(imino carbonates), poly(N-acylhydroxyproline)esters, poly(N-palmitoyl hydroxyproline) esters, ethylene-vinyl acetate copolymers, poly(orthoesters), poly(caprolactones), and poly(phosphazenes). In the case of biodegradable polymers, media contaminants can be advantageously metabolized in vivo to biologically acceptable products that can be eliminated from the body. Additional grinding media (21) materials include digestible ingredients having “GRAS” (generally recognized as safe) status. For instance, starch based materials or other carbohydrates, protein based materials, and salt based materials. Any size of grinding media (21) suitable to achieve the desired particle size can be utilized. However, in many applications the preferred size range of the grinding media (21) will be in the 15 mm to 20 micron range for continuous media milling with media retention in the mill.

In situations involving either metal (oxide) contamination, or shifts in pH, a polymeric grinding media may be utilized. The present invention may use grinding media (21) having either a spherical (e.g., milling beads) or nonspherical shape. The present invention may also utilize a combination of spherical and nonspherical grinding media.

Nonspherical media for use in the present invention includes polymeric resins, biodegradable polymeric resin, biodegradable polymers, grinding media comprising a core portion having a coating of tough resilient material adhered thereon, made by a variety of processes as set forth in Application Ser. No. 60/427,122 (FL1082) which is incorporated herein by reference in its entirety.

Any size of grinding media (21) suitable to achieve the desired particle size can be utilized, however, in many applications the preferred size range of the grinding media will be in the 5000 to 10 micron range for continuous media milling with media retention in the mill.

For batch media milling (in attritors) or circulation milling in which slurry and grinding media are circulated, smaller grinding media is often utilized.

Media milling methods can be carried out under a variety of pressure conditions. For example, typical media milling is traditionally carried out under conditions around ambient conditions up to 2 bars (about 29 psi). Ambient processing pressures are typical of ball, attritor and vibratory mills. However, the operating pressures and temperatures of the present invention vary according to the product and fluid used in the process as well as the size of the milling apparatus. For example, processing pressures of about 2 bars (about 29.0 psi or about 2.0 kgf/cm²) up to about 300 bars (about 4351.1 psi or about 305.9 kgf/cm²) at a temperature ranging from about supercooling −20° C. (20 degrees below 0° C.) to about 100° C. are preferred.

The preferred proportions of grinding media (21), the product, and the inactive agent(s) present in the grinding chamber (3) of the mill (1) can vary within wide limits depending, for example, on the particular pharmaceutical, agricultural, nutraceutical, or diagnostic agent selected, the size and density of the grinding media, the type of mill selected, etc.

The process can be carried out in a continuous, batch or semi-batch mode. The embodiments of the present invention may be operated “fluid full”, wherein there is no headspace, however, in the case of liquefied gases a headspace filled with gas may exist. In the present invention, the grinding media (21) typically occupies from about 0 to about 95 volume-% of the chamber, preferably about 50% to about 90%, more preferably about 70-80%, most preferably about 75%.

After milling is completed, the grinding media (21) is preferably separated from the milled product (in either a dry or liquid dispersion form) by the use of the optional plunger (14) having the optional mesh retention screen (13), or alternatively the gap separator, removeably attached thereto.

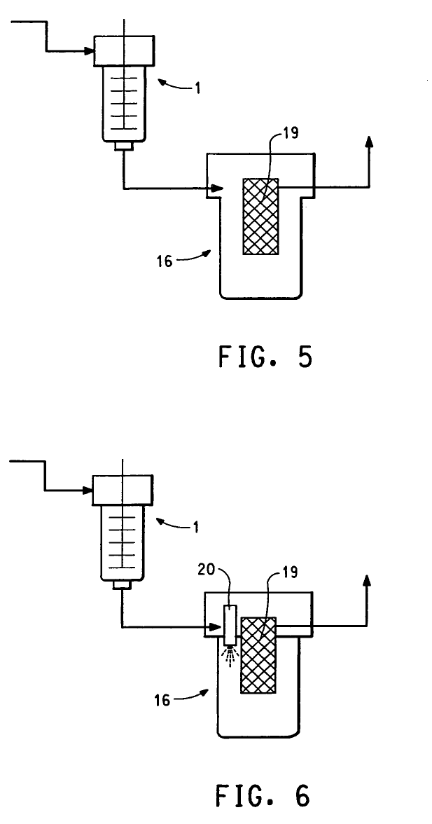

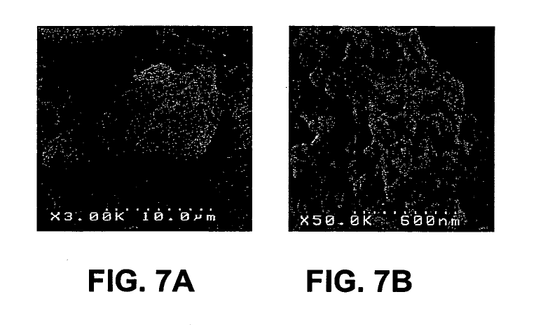

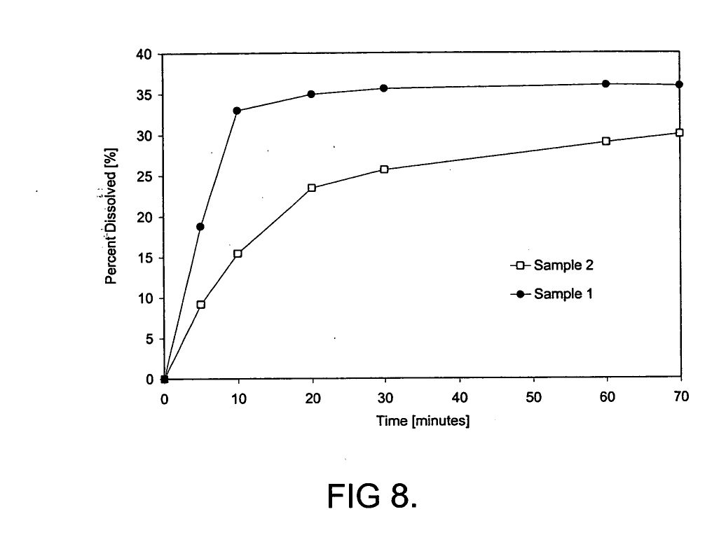

Upon exiting, the milled particles may be removed from the fluid using a means for product collection/separation (16). Conditions under which product collection occurs may be determinitive of the degree of reagglomeration and strength of agglomerates. The product, fluid and grinding media (21) are separated/collected using a means for separation and/or collection (16) known in the art such as, for example a high pressure filter or orifice collector; as well as those techniques generally known to persons skilled in the art such as, for example, the 4500 series filter assembly having part no. 4532GP-0.5 ABSFL, available from Norman Filter Company, Bridgeview Ill.). Suitable means for separation/collection (16) that are well known in the art include those using separation techniques such as filtration (i.e., pressurized filtration, where the system pressure is released after the filter through a flow control valve (for example, see FIG. 5)), solid/liquid or solid/gaseous separation techniques (i.e., flash-drying where the mill contents are sprayed into the collection filter housing, having the pressure released before the filter; spray-drying, oven-drying, and air-drying (for example, see FIG. 6)), sieving through a mesh screen (19), dispersion nozzles (20), high pressures cyclones and the like. While the majority of product is removed from the system using the disclosed processes, any substances that build up on the inner walls of the system (22) or its components may be isolated and/or discarded during routine maintenance or collected in conjunction with the flush-through cleaning process. Typically, the system and process according to the embodiments of the present invention produce a high product yield, wherein the yield typically ranges from about 30% to about 95%.

When using a high pressure media mill (1) containing a pressurized volatile fluid, the grinding fluid advantageously is separated from the grinding media (21) and the ground particles by vaporization after milling when the process is returned to ambient pressure by gas/solid separation after product collection.

Generally, the high pressure media mill (1) of the system of the present invention operates by having the fluid travel into the high pressure media mill (1) via the charging port (8) and through the charging pipe to introduce the fluid to the grinding chamber (3) which contains the product, agitator (6) and grinding media (21). The product-containing fluid is caused to rapidly rotate within the grinding chamber (3) due to the high-speed rotation of the agitator (6) and the grinding media (21). The centrifugal force that is generated by the spinning agitator (6), and aided by the grinding media (21), transports the product-containing fluid in a radial direction towards the wall of the grinding chamber (3), thereby circulating the product-containing fluid to ensure complete and uniform grinding. As the product-containing fluid approaches the agitator (6) it would normally encounter a stagnant zone, however, the force from the agitator generated by the high circumferential speed of the at least one agitation element (7) prevents the formation of such zones. Subsequent to agitation the milled product is transported via pressure and/or gravity towards a discharge port (10) and the optional plunger (14), wherein the retention screen (13) provides for the separation of the product-containing carrier fluid from the grinding media 21) for collection, further reaction or isolation. The product-containing fluid typically exits the grinding chamber (3) via the discharge port (10) through a discharge pipe and moves toward a means for separation/collection (16).

The embodiments of the process of the present invention also enables control of particle size. The size range of particles that may be formed is typically from about 100 nm to about 100 μm. The preferred size of the crystals is 100 nm to 10 μm with a narrow distribution range. For example, the embodiments of the present invention can provide a narrow distribution range for applications such as inhalation products, wherein the drug is converted from a bulk dry powder to particles ranging in size from about 1 to about 5 micrometers, preferably about 3 to about 5 micrometers. The size of the particles that are produced is related to the mechanical properties of the particulate matter and the operational settings of the mill (1) as well as the solubility, residence time in the grinding chamber (3), fluid properties, presence of surfactant (which aids in obtaining an equilibrium between milling and agglomeration) and reaction properties of the chemical system being used.

Temperature and pressure of operation are parameters that can affect the yield of the process due to its affects on solvency and thermodynamic and physical properties of the supercritical fluids. The process of the present invention requires the temperature to be appropriate so that proper milling results. The substance to be ground by means of the invention will often be milled at a temperature that does not cause the substance to significantly degrade or lose efficacy. Complete or partial dissolution or plasticization of stabilizers or coating agents may improve mass transfer to the particle's surface. Co-solvents can also be added for increased effects. The coating preferably solidifies during product collection. Preferably in the case of substances such as pharmaceuticals, cosolvents of the present invention are chosen from those that do not adversely effect human health. Representative cosolvents include water, ethanol, isopropyl alcohol, polyethylene glycol, propylene glycol and dipropylene glycol and mixtures thereof.

General operating temperatures for the present invention can range from about −20° C. to about 100° C., preferably ranging from about 30° C. to about 70° C., more preferably ranging from about 20° C. to about 50° C., are ordinarily preferred if the ground substance is an organic active agent. Toward this end, the processing equipment can be cooled using conventional cooling equipment. Super cooling conditions can also be employed if the fluid selected is a gas at ambient temperature.

The embodiments of the present invention may optionally further comprise various features to allow for the regulation of the temperature via heat transfer units which may either cool or heat the fluid such as a heat transfer mechanism (18). For example, the housing of the present invention may be double walled or jacketed for heat transfer and/or control of temps within the housing and grinding chamber in the avoidance of large temperature swings at high pressures. An example of suitable heat transfer mechanisms include, but are not limited to a chiller heat exchanger having part no. TSF-4225, available from Sentry Equipment Company.

Typically, in the embodiments of the process of the present invention, the use of a surfactant is preferred in order to aid in the prevention of flocculation of the milled particles. In addition, the surfactant should be soluble with the fluid utilized in the process, whereas the active ingredient should be insoluble.

The processing or milling time can also vary widely depending primarily on the particular mechanical means and processing conditions selected. For ball mills, processing times of up to five days or longer may be required. On the other hand, processing times of less than one day (residence of one minute to several hours) have provided the desired results using a high shear media mill. The general range for the milling time in the present invention ranges from about 0.5 hours to about 8 hours, preferably about 1 hour.

A recirculating configuration is also contemplated by the present invention, wherein the flow of particles from the discharge port may be circulated back into the high pressure media mill of the present invention. The recirculation configuration of a fraction of the product may be used to mill the product in stages or to ensure complete milling of the product.

The embodiments of the process and apparatus of the present invention can be utilized to mill a wide variety of substances, particularly pharmaceutical (including pharmaceuticals used for human porpuses as well as those used in veterinary purposes), agrochemicals, diagnostics agents and/or nutracueticals.

The water soluble and water insoluble pharmaceutical substances that can be milled according to the present invention include, but are not limited to, anabolic steroids, analeptics, analgesics, anesthetics, antacids, anti-arrthymics, anti-asthmatics, antibiotics, anti-cariogenics, anticoagulants, anticolonergics, anticonvulsants, antidepressants, antidiabetics, antidiarrheals, anti-emetics, anti-epileptics, antifungals, antihelmintics, antihemorrhoidals, antihistamines, antihormones, antihypertensives, anti-hypotensives, anti-inflammatories, antimuscarinics, antimycotics, antineoplastics, anti-obesity drugs, antiplaque agents, antiprotozoals, antipsychotics, antiseptics, anti-spasmotics, anti-thrombics, antitussives, antivirals, anxiolytics, astringents, beta-adrenergic receptor blocking drugs, bile acids, breath fresheners, bronchospasmolytic drugs, bronchodilators, calcium channel blockers, cardiac glycosides, contraceptives, corticosteriods, decongestants, diagnostics, digestives, diuretics, dopaminergics, electrolytes, emetics, expectorants, haemostatic drugs, hormones, hormone replacement therapy drugs, hypnotics, hypoglycemic drugs, immunosuppressants, impotence drugs, laxatives, lipid regulators, mucolytics, muscle relaxants, non-steroidal anti-inflammatories, nutraceuticals, pain relievers, parasympathicolytics, parasympathicomimetics, prostagladins, psychostimulants, psychotropics, sedatives, sex steroids, spasmolytics, steroids, stimulants, sulfonamides, sympathicolytics, sympathicomimetics, sympathomimetics, thyreomimetics, thyreostatic drugs, vasodialators, vitamins, xanthines, and mixtures thereof.

Suitable diagnostic agents include, but are not limited to, ethyl-3,5-bisacetoamido-2,4,6-triiodobenzoate (WIN 8883), ethyl(3,5-bis(acetylamino)-2,4,6-triiodobenzoyloxy)acetate (WIN 12901), ethyl-2-(bis(acetylamino)-2,4,6-triiodobenzoyloxy)butyrate (WIN 16318), 6-ethoxy-6-oxohexyl-3,5-bis(acetylamino)-2,4,6-triiodobenzoate (WIN 67722) and mixtures thereof. Other suitable imaging agents are described in EPO 498, 482, the disclosure of which is hereby incorporated by reference. Diagnostic agents also include any other particulate material that is useful in vivo or in vitro in the detection or quantitation of a health or disease.

Suitable nutraceuticals may include, but are not limited to, dietary supplements, such as vitamins and minerals, herbal remedies, such as Asian ginseng, bilberry, black cohash, cascara, cat's claw, cayenne, cranberry, devil's claw, dong quai, echinacea, evening primrose oil, feverfew, garlic, ginger, ginkgo biloba, ginseng, golden seal, gotu kola, grape seed, green tea, hawthorn, kava, licorice, milk thistle, saw palmetto, Siberian ginseng, St. John's wort, valerian root, probiotics, and functional foods, such as Yakult (a cross between food and pharmaceuticals) and mixtures of those described above. In addition, any matter that is normally ingested by humans or animals for sustenance, growth and maintenance of optimal health is considered a food or food substance that can be used as a source of nutraceuticals.

Suitable agricultural chemicals may include nanoparticulate compositions that can be applied to plant tissue such as, for example, insecticidal ingredients applied to seeds, plants, trees, harvested crops, soil, and the like. The insecticide ingredient can be selected from a wide variety of organic compounds or mixtures which are known and used in agriculture and horticulture applications, such as those listed in W. T. Thomson, Agricultural Chemicals, Book I, Insecticides (Thomson Publications, Fresno, Calif. 1989).

Further suitable agricultural chemicals include insecticidal compounds, agricultural agents, germicides, plant growth regulating agents, and herbicides (including, but not limited to, for example, photosynthesis inhibitors, pigment inhibitors growth inhibitors, amino acid synthesis, lipid biosynthesis inhibitors, cell wall biosynthesis inhibitors, and rapid cell membrane disruptors), and mixtures of those described above, among others.

The general categories of insecticidal-active organic compounds include chlorinated hydrocarbon derivatives, phosphorated derivatives, pyrethroids, acylureas, and the like. Chlorinated hydrocarbon insecticides usually act as stomach and contact poisons affecting the nervous system. They are persistent in the environment and tend to accumulate in animal fatty tissue, as exemplified by DDT and chlordane.

Illustrative of other insecticidal compounds are chlorfluazuron, chlorpyrifos, chlorpyrifos methyl, bromophos, diazinon, malathion, trichlorfon, dimethoate, phorate, lindane, toxaphene, diflubenuron, methomyl, propoxur, carbaryl, cyhexatin, cypermethrin, permethrin, fenvalerate, dicofol, tetradifon, propargite, and the like. Other examples of insecticides include the pyrethroid insecticides, such a Fenvalerate.™. [.alpha.-cyano-3-phenoxybenzyl-2-(4-chlorophenyl)-3methyl-valerate] and Pyrethroid.™. [cyano(4-fluoro-3-phenoxyphenylmethyl-3-(2,2-dichloroethenyl)-2,2-dimethyl cyclopropanecarboxylate]; organophosphorus insecticides, such as DDVP.™. (2,2-dichlorovinyldimethyl phosphate), Sumithion.™. (dimethyl-4-nitro-m-tolylphosphorothionate), Malathone™ {S-[1,2-bis(ethoxycarbonyl)ethyl]dimethyl-phosphorothiolthionate}, Dimethoate [dimethyl-S-(N-methylcarbamoylmethyl)-phosphorothios thionate), Elsan.™. {S-[.alpha.-(ethoxycarbonyl)benzyl]dimethylphosphoro-thiol thionate), and Baycid.™. [O,O-dimethyl-O-(3-methyl-4methylmercaptophenyl)thiophosphate]; carbamate; insecticides such as Bassa.™. (O-butylphenyl methylcarbamate), MTMC.™. (m-tolyl methylcarbamate), Meobal.™. (3,4-dimethylphenyl-N-methylcarbamate), and NAC.™. (1-naphthyl-N-methylcarbamate); as well as Methomyl.™. {methyl-N[(methylcarbamoyl)oxy]thioacetimide} and Cartap.™. {1,3-bis(carbamolythio)-2-(N,N-dimethylamino)propane hydrochloride} and mixtures of those described above.

Examples of other agricultural agents include acaricides such as, but not limited to, Smite.™. {2-[2-(p-tert-butylphenoxy)isopropoxy]isopropyl-2-chloroethylsulfide}, Acricid.™. (2,4-dinitro-6-sec-butylphenyl dimethylacrylate), Chlormit.™. (isopropyl 4,4-dichlorobenzylate), Acar.™. (ethyl 4,4-dichlorobenzylate), Kelthane.™. [1,1-bis(p-chlorophenyl)-2,2,2-trichloroethanol], Citrazon.™. (ethyl 0-benzoyl-3-chloro-2,6-dimethoxybenzohydroxymate), Plictran.™. (tricyclohexyltin hydroxide), and Omite.™. [2-(p-tert-butylphenoxy)cyclo-hexyl-2-propinyl sulfite] and mixtures of those described above.

Examples of germicides include organosulfur germicides, such as Dithane.™. (zinc ethylenebisdithiocarbamate), Maneo.™. (manganese ethylenebis-dithiocarbamate), Thiuram.™. [bis(dimethylthiocarbamoyl)disulfide], Benlate.™. [methyl 1-(butylcarbamoyl)-2-benzimidazole carbamate], Difolatan.™. (N-tetrachloroethylthio-4-cyclohexane-1,2-dicarboxyimide), Daconol.™. (tetrachloroisophthalonitrile), Pansoil.™. (5-ethoxy-3-trichloromethyl-1,2,4-thiadiazole), Thiophanate-methyl[1,2-bi-s(3-methoxycarbonyl-2-thioureido)benzene], Rabcide.™. (4,5,6,7-tetrachlorophthaloid), Kitazin P.™. (O,O-diisopropyl-S-benzyl phosphorothioate), Hinonsan.™. (0-ethyl-S,S-diphenyldithiophosphate), and Propenazol.™. (3-allyloxy-1,2-benzothiazole 1,1-dioxide) and mixtures of those described above.

Examples of plant growth regulating agents include, but are not limited to, MH.™. (maleic acid hydrazide) and Ethrel.™. (2-chloroethylphosphonic acid) and mixtures of those described above.

Examples of herbicides include, but are not limited to Stam.™. (3,4-dichloropropionanilide), Saturn.™. [S-(4-chlorobenzyl) N,N-diethylthiolcarbamate), Lasso (2-chloro-2′,6′-diethyl-N-(methoxymethyl)acetanilide), Glyphosate.™. [N-(phosphonomethyl)glycine isopropylamine salt], DCMU [3-(3,4-dichlorophenyl)-1,1-dimethylurea), and Gramoxone.™. (1,1′-dimethyl-4,4′-dipyridium dichloride] and mixtures of those described above.

Other herbicides contemplated for use in the present invention include auxin transport inhibitors, e.g., naptalam; growth regulators, including benzoic acids, e.g., dicamba; phenoxy acids, such as (i) acetic acid type, e.g., 2,4-D, MCPA, (ii) propionic acid type, e.g., 2,4-DP, MCPP, and (iii) butyric acid type, e.g., 2,4-DB, MCPB; picolinic acids and related compounds, e.g., picloram, triclopyr, fluroxypyr, and clopyralid; and mixtures of those described above.

Photosynthesis inhibitors are also herbicides useful in the compositions of the invention. Such compounds include but are not limited to (a) s-triazines, such as (i) chloro substituted, e.g., atrazine, simazine, and cyanazine, (ii) methoxy substituted, e.g., prometon, (iii) methylthio substituted, e.g., ametryn and prometryn; (b) other triazines, such as hexazinone, and metribuzin; (c) substituted ureas, such as diuron, fluometuron, linuron, tebuthiuron, thidiazuron, and forchlorfenuron; (d) uracils, such as bromacil and terbacil; and (e) others, such as bentazon, desmedipham, pheninedipham, propanil, pyrazon, and pyridate; and mixtures of those described above.

Pigment inhibitors are also herbicides useful in the compositions of the invention. Such compounds include but are not limited to pyridazinones, such as norflurazon; isoxazolones, such as clomazone; and others, such as amitrole and fluridone and mixtures of those described above.

In yet another aspect of the invention, growth inhibitors are herbicides useful in the compositions of the invention. Such compounds include but are not limited to (a) mitotic disruptors, such as (i) dinitroanilines, e.g., trifluralin, prodiamine, benefin, ethalfluralin, isopropalin, oryzalin, and pendimethalin; and (ii) others, such as DCPA, dithiopyr, thiazopyr, and pronamide; (b) inhibitors of shoots of emerging seedlings, such as (i) thiocarbamates, e.g., EPTC, butylate, cycloate, molinate, pebulate, thiobencarb, triallate, and vernolate; (c) inhibitors of roots only of seedlings, such as bensulide, napropamide, and siduron; and (d) inhibitors of roots and shoots of seedlings, including chloroacetamides, such as alachlor, acetochlor, metolachlor, diethatyl, propachlor, butachlor, pretilachlor, metazachlor, dimethachlor, and cinmethylin; and mixtures of those described above.

Amino acid synthesis inhibitors are herbicides useful in the compositions of the invention. Such compounds include, but are not limited to, (a) glyphosate, glufosinate; (b) sulfonylureas, such as rimsulfuron, metsulfuron, nicosulfuron, triasulfuron, primisulfuron, bensulfuron, chlorimuron, chlorsulfuron, sulfometuron, thifensulfuron, tribenuron, ethametsulfuron, triflusulfuron, clopyrasulfuron, pyrazasulfuron, prosulfuron (CGA-152005), halosulfuron, metsulfuron-methyl, and chlorimuron-ethyl; (c) sulfonamides, such as flumetsulam (a.k.a. DE498); (d) imidazolinones, such as imazaquin, imazamethabenz, imazapyr, imazethapyr, and imazmethapyr; and mixtures of those described above.

Lipid biosynthesis inhibitors are herbicides useful in the compositions of the invention. Such compounds include, but are not limited to, (a) cyclohexanediones, such as sethoxydim and clethodim; (b) aryloxyphenoxys, such as fluazifop-(P-butyl), diclofop-methyl, haloxyfop-methyl, and quizalofop; and (c) others, such as fenoxaprop-ethyl; and mixtures of those described above.

Cell wall biosynthesis inhibitors are herbicides useful in the compositions of the invention. Such compounds include, but are not limited to, dichlobenil and isoxaben and mixtures of those described above.

Rapid cell membrane disruptors are herbicides useful in the compositions of the invention. Such compounds include, but are not limited to, (a) bipyridiliums, such as paraquat, and diquat; (b) diphenyl ethers, such as acifluorfen, fomesafen, lactofen, and oxyfluorfen; (c) glutamine synthetase inhibitors, such as glufosinate; and (d) others, such as oxadiazon; and mixtures of those described above.

Miscellaneous herbicides useful in the compositions of the invention include, but are not limited to, (a) carbamates, such as asulam; (b) nitriles, such as bromoxynil and ioxynil; (c) hydantocidin and derivatives; and (d) various other compounds, such as paclobutrazol, ethofumesate, quinclorac (a.k.a. BAS514), difenzoquat, endothall, fosamine, DSMA, and MSMA; and mixtures of those described above.

Other herbicides useful in the compositions of the invention include, but are not limited to, triketones and diones of the type described in U.S. Pat. Nos. 5,336,662 and 5,608,101, the contents of each of which are incorporated herein by reference, and in EP-A-338-992; EP-A-394-889; EP-A-506,967; EP-A-137,963; EP-A-186-118; EP-A-186-119; EP-A-186-120; EP-A-249-150; and EP-A-336-898. Examples of such triketones and diones are sulcotrione (MIKADO.™.), whose chemical designation is 2-(2-chloro-4-methanesulfonylbenzoyl)-1,3-cyclohexanedione: 2-(4-methylsulfonyloxy-2-nitrobenzoyl)-4,4,6,6-tetramethyl-1,3-cyclohexane dione; 3-(4-methylsulfonyloxy-2-nitrobenzoyl)-bicyclo[3,2,1]octane-2,4-dione3-(4-methylsulfonyl-2-nitrobenzoyl)-bicyclo[3,2,1]octane-2,4-dione; 4-(4-chloro-2-nitrobenzoyl)-2,6,6-trimethyl-2H-1,2-oxazine-3,5(4H,6H)dione; 4-(4-methylthio-2-nitrobenzoyl)-2,6,6-trimethyl-2H-1,2-oxazine-3,5(4H,-6H)-dione; 3-(4-methylthio-2-nitrobenzoyl)-bicyclo[3,2,1]octane-2,4-dione; 4-(2-nitro-4-trifluoromethoxybenzoyl)-2,6,6-trimethyl-2H-1,2-oxazine-3,5-(4H,6H)-dione; and mixtures of those described above.

Useful herbicidal candidate compounds are described in U.S. Pat. No. 5,506,192; EP-A-461,079; EP-A-549,524; EP-A-315,589 and PCT Appln. No. 91/10653. The contents of all of the cited references are incorporated herein by reference; including for example 3-[(4,6-dimethoxy-2-pyrimidinyl)hydroxymethyl]-N-methyl-2-pyridine carboxamide; 4,7-dichloro-3-(4,6-dimethoxy-2-pyrimidinyl)-3-hexanoyloxyphthalide; 3-[(4,6-dimethoxy-2-pyrimidinyl)carbonyl]-N,N-dimethyl-2-pyridine carboxamide; 3,6-dichloro-2-[(4,6-dimethoxy-2-pyrimidinyl)carbonyl]benzoicacid; 6-chloro-2-[(4,6-dimethoxy-2-pyrimidinyl)thio]benzoic acid (a.k.a. DPX-PE350 or pyrithiobac) and salts and derivatives thereof; and mixtures of those described above.

As previously noted, embodiments of the process and system of the present invention can also be used with a wide variety of other industrial substances, such as, for example foods and food ingredients. The water soluble and water insoluble foods and food ingredients that can be milled include, but are not limited to, soy, carbohydrates, polysaccharides, oligosaccharides, disaccharides, monosaccharides, proteins, peptides, amino acids, lipids, fatty acids, phytochemicals, vitamins, minerals, salts, food colors, enzymes, sweeteners, anti-caking agents, thickeners, emulsifiers, stabilizers, anti-microbial agents, antioxidants, and mixtures thereof.

Further substances that can be milled in the process and apparatus of the present invention include, but are not limited to bioactives as defined above, for example, poorly water soluble drug compounds, such as, for example class 2 or class 4 pharmaceuticals. The present invention provides the ability to create bioactive materials, preferably crystals, that are finer than typically produced by bulk crystallization (about 50 micron) or by bulk crystallization followed by various commonly used milling processes (commonly about 10 micron) and thus the inventive process will enable poorly water soluble bioactives to have a higher dissolution rate.

Furthermore, the pharmaceutical or biopharmaceutical substances may be those delivered via a pulmonary delivery mechanism, a parenteral delivery mechanism, a transdermal delivery mechanism, an oral delivery mechanism, an ocular delivery mechanism, a suppository or vaginal delivery mechanism, an aural delivery mechanism, a nasal delivery mechanism, sublingual delivery; buccal delivery and an implanted delivery mechanism.

Further substances include metal particles, such as for example silver, gold, platinum, copper, tin, iron, lead, magnesium, titanium, mixtures thereof and the like. These substances may be used in applications such as, inter alia, electronic materials.

The skilled practitioner will also realize that many other types of articles may be milled according to the invention for applications in other fields.

In addition, the embodiments of the present invention may be utilized for the production of any variety of small, high surface area particles that can be used as carrier particles for liquids or as seeds for crystallization or precipitation.

The particles can, in many cases, also be concurrently or subsequently coated with moisture barriers, taste-masking agents, or other additives that enhance the attributes of the pharmaceuticals, nutraceuticals or diagnostic agent. Likewise, the active substance crystals/particles can be formulated with other inactive agents (such as excipients, surfactants, polymers) to provide the substance in an appropriate dosage form (e.g. tablets, capsules, etc.). Thus, in the embodiments of the process of the present invention, in addition to the product, a surfactant, surface modifier, emulsifier, stabilizer may be introduced as a third stream into the high shear zone, resulting in the stabilization, surface modification and encapsulation of the precipitated dispersion.

As noted above, particles of pharmaceuticals, agrochemicals, nutraceuticals and diagnostic agents can also be milled with other materials during the milling process, which is co-grinding or co-milling. Most often the other material will be an inactive agent, which may include, for example, excipients, surfactants, dispersants, polymers, fillers, flow-aids, binders, coating agents, colorants and mixtures of these described inactive agents. Thus, a surface modifier, such as a surfactant, emulsifier, or stabilizer, can be adsorbed on the surface of the pharmaceutical, agricultural, nutraceutical or diagnostic agent particle during the milling process. Useful surface modifiers are believed to include those that physically adhere, as well as, those that chemically bond, to the surface of the pharmaceutical, agricultural, nutraceutical or diagnostic particle. Surface modifiers can be present in an amount of 0.1-90%, preferably 1-80% by weight based on the total combined weight of the respective substance and the surface modifier. Suitable coating agents/surface modifiers include acrylic resins/dispersants, fluorinated acrylics, ethylene acids, methacrylic acids, acrylic acid copolymers, PLA (polylactic acid), and PLGA (poly(lactic-co-glycolic acid)).

The embodiments of the present invention may be further carried out in the presence of at least one surfactant, which is believed to result in surfactant deposited or adsorbed at the surface of the fine particles, which increases stability and redispersability of the particles. Surfactants of the present invention are chosen from those that do not adversely effect human health when delivered to the pulmonary airways. They may be cationic, amphoteric, nonionic or anionic. The present surfactants may have a molecular weight of about 500 or less where halogen-free, and a molecular weight of about 1000 or less where halogenated, and contain a hydrophilic moiety and a hydrophobic moiety. The surfactant hydrophobic moiety comprises an aliphatic hydrocarbon group containing at least 10 carbon atoms. The surfactant hydrophilic moiety comprises a cationic (e.g., aliphatic ammonium), amphoteric (e.g., amine betaines), nonionic (e.g., oxyalkylene oligomers, sugar alcohols (e.g., sorbitol), mono- and disaccarides (e.g., sucrose, lactose, maltose)) or anionic (e.g., carboxylate, phosphate, sulfate, sulfonate, sulfosuccinate) group. Representative surfactants include: stearic acid (CH₃(CH₂)₁₆CO₂H), oleic acid (CH₃(CH₂)₇CH═CH(CH₂)₇CO₂H), sodium lauryl sulfate (CH₃(CH₂)₁₁OSO₃Na), Aerosol OT® (dioctyl sodium sulfosuccinate(Cytec Industries)), Neodol® 25-7 (HO[CH₂CH₂O]₇₋₈(CH₂)₁₂₋₁₅OH (Shell Chemicals)), Span® 80 (sorbitan monooleate (Uniqema)), Ethomeen® C/15 ((C₈₋₁₅ alkyl, primarily C₁₂)N[(CH₂CH₂O)ₘH][CH₂CH₂O)ₙH] (Akzo Nobel)), and Zonyl® FSP (F(CF₂CF₂)₁₋₇CH₂CH₂O)₁₋₂P(O)(ONH₄)₁₋₂ (DuPont)). Preferred amongst the surfactants is sodium lauryl sulfate (CH₃(CH₂)₁₁OSO₃Na).

The amount of surfactant used in the present milling process may be from about 0 weight percent to an amount that is greater than the solubility limit of said surfactant in a particular formulation of particulate/surfactant/optional dispersant/cosolvent, preferably from about 0 weight percent to about 30 weight percent, based on the total weight of surfactant, particulate matter and optional dispersant.

The embodiments of the present may also be carried out in the presence of a dispersant. Dispersants of the present invention are chosen from those that do not adversely effect human health when delivered to the pulmonary airways. They may be cationic, amphoteric, nonionic or anionic. The present dispersants may have a molecular weight of about 500 or greater and contain a hydrophilic moiety and a hydrophobic moiety. The dispersant hydrophobic moiety comprises an aliphatic hydrocarbon group containing at least 10 carbon atoms. The dispersant hydrophilic moiety comprises a cationic (e.g., aliphatic ammonium), amphoteric (e.g., amine betaines), nonionic (e.g., oxyalkylene oligomers, sugar alcohols (e.g., sorbitol), polysorbates, polysaccarides) or anionic (e.g., carboxylate, phosphate, sulfate, sulfonate, sulfosuccinate) group. Representative dispersants include: phospholipids (e.g., soy lecithin), polysaccharides (e.g., starch, glycogen, agar, carrageenan), polysorbate 80, Span® 85 (sorbitan trioleate (Uniqema)), Pluronics 25R4 and Pluorincs P104.

The amount of dispersant used in the present milling process may be from about 0 weight percent to an amount that is greater than the solubility limit of said dispersant in a particular formulation of the particulate matter/surfactant/optional dispersant/cosolvent, preferably from about 0 weight percent to about 0.5 weight percent, based on the total weight of surfactant, particulate matter and optional dispersant.

Further, suitable inactive agents are preferably selected from known organic and inorganic additives. Such additives include various polymers, low molecular weight oligomers, natural products and surfactants. Preferably, these additives include nonionic and anionic surfactants. Representative examples of such additives include gelatin, casein, lecithin (phosphatides), gum acacia, cholesterol, tragacanth, stearic acid, benzalkonium chloride, calcium stearate, magnesium stearate, glyceryl monostearate, cetostearl alcohol, cetomacrogol emulsifying wax, sorbitan esters, polyoxyethylene alkyl ethers, e.g., macrogol ethers such as cetomacrogol 1000, polyoxyethylene castor oil derivatives, polyoxyethylene sorbitan fatty acid esters, e.g., the commercially available Tweens, polyethylene glycols, polyoxyethylene stearates, colloidal silicon dioxide, phosphates, sodium dodecylsulfate, carboxymethylcellulose calcium, carboxymethylcellulose sodium, methylcellulose, hydroxyethylcellulose, hydroxypropylcellulose, hydroxypropylmethylcellulose, hydroxypropylmethylcellulose phthalate, noncrystalline cellulose, microcrystalline cellulose, magnesium aluminum silicate, triethanolamine, polyvinyl alcohol, and polyvinylpyrrolidone (PVP). Most of these additives are described in detail in the Handbook of Pharmaceutical Excipients, published jointly by the American Pharmaceutical Association and The Pharmaceutical Society of Great Britain, 1986, the disclosure of which is hereby incorporated by reference in its entirety. The aforementioned additives are commercially available and/or can be prepared by techniques known in the art.

An additional advantage of this system, particularly the high pressure media mill is its ease of cleaning. A cleaning solution can be selected that will dissolve any internal encrustation and the force characteristics of the operating media mill enables the device to self clean without the need to disassemble and scrub internal surfaces. Alternatively, the apparatus may be disassembled for cleaning to comply with various procedures necessary for pharmaceutical applications.

As was previously discussed, and as will be evident to a person of ordinary skill in the art, the size of the particles obtained according to the process of the present invention may be controlled by adjusting the parameters of the process. For example, increasing the RPM of the agitator will often lead to finer particles, and adjusting the rate of addition and/or agitation will alter the particle size. Any one, several, or all of the process parameters may be adjusted in order to obtain the desired particle habit and/or size. A person of ordinary skill in the art may determine, using routine experimentation, the process parameters that are the most optimal in each individual situation.

Various methods may be employed in order to monitor the crystallinity of the particles of the present invention. Methods well known to persons skilled in the art include X-ray diffraction, differential scanning calorimetry (DSC) and scanning electron microscopy (SEM). Dissolution testing, particle size analysis and NMR spectroscopy.

Other milling methods can be utilized within the high pressure system described above, wherein such milling methods do not utilize grinding media. These alternative milling methods utilize shear forces and compressive forces (in the case of liquidfied gases) and a nozzle homogenization act to mill the product. An example of this type of mill is a rotor-stator apparatus.

Particle size formation is more clearly demonstrated by the examples set forth below. The sizes demonstrated in the examples are specific to the example material under the tested conditions, and are not limitations to be placed on any other substances that may be milled.

### EXAMPLES

The present invention is further defined in the following Examples, in which all parts and percentages are by weight. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usage and conditions.

All references cited in the present disclosure are hereby specifically incorporated by reference in their entirety.

### Example 1

### Media Milling of Lactose Crystals in Supercritical Carbon Dioxide

Nylon grinding media with a size of 500 microns (Norstone Inc., Wyncote, Pa., USA) was added to the 1-liter Dupont high pressure media mill, so that 74.4% of the grinding chamber was filled with the grinding media (bulk volume). A physical blend of 100 grams of USP grade lactose (Spectrum Chemicals) and 2 grams surfactant Oleic Acid (VWR) was added to the grinding chamber.

The mill was sealed and filled with CO₂ at supercritical conditions (temperature of 35° C. and pressure of 1450 psi). The dispersion was milled at a mill speed of 1786 RPM for 60 minutes. After completion of the milling, the mill was purged with supercritical CO₂ at 800 psi. The grinding media were retained inside the grinding chamber by a 440 micron grinding media retention screen (Swagelok). The milled product particles were entrained in the purging CO₂ stream and discharged through the bottom outlet and carried to the high pressure filter housing. The product particles were collected on the 400 nm porous metal filter (Norman Filter).

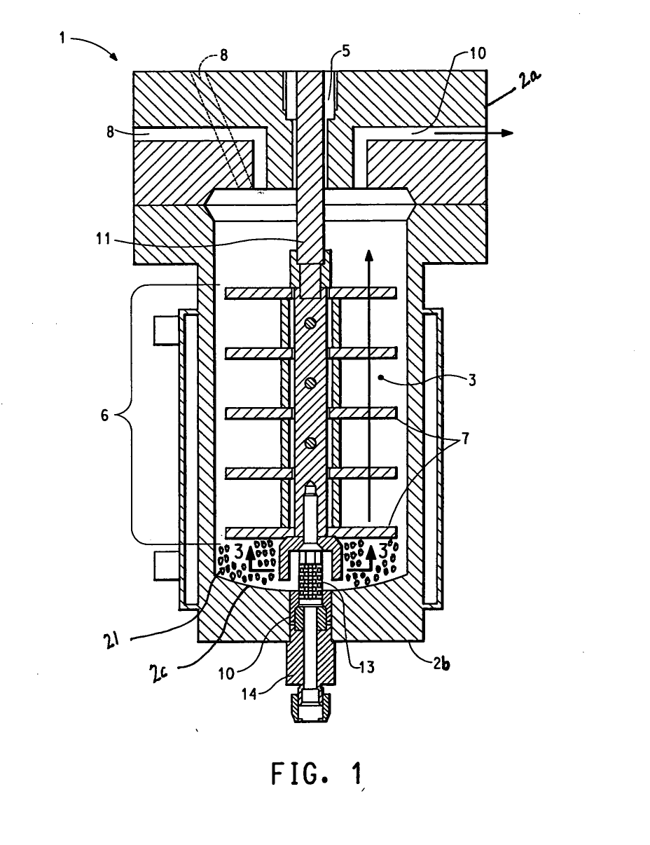

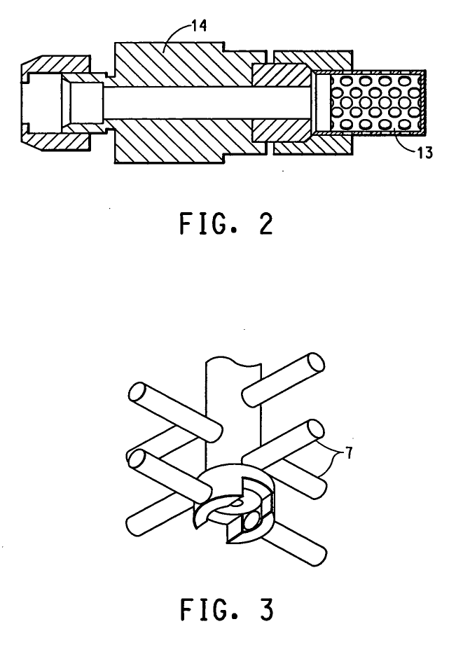

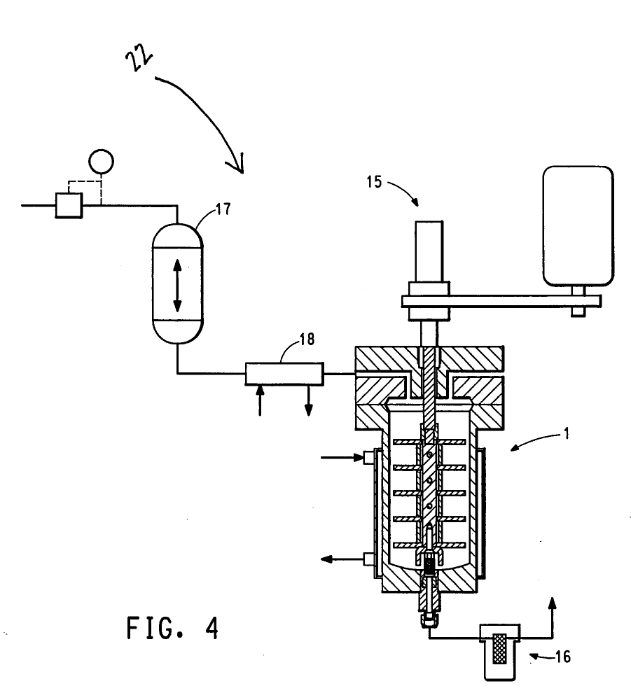

The end product produce was a white powder with no noticeable discoloration. The mass of the product recovered from the filter was 68.5 grams. A Malvern Mastersizer 2000 (Malvern Instruments, Worcestershire, UK) was used to measure the size of the lactose particles collected in the high pressure filter. The median particle size was 75.889 microns. The 10% cumulative undersize was 3.0 micron. The 90% cumulative undersize was 796 micron. Particle Scanning micrographs (SEM, Hitachi S-4700, San Jose, Calif.) of the milled product (FIG. 1) were taken showing agglomeration resulting in a porous submicron granular structure.

### Example 2

### Media Milling of Ibuprofen in Supercritical Carbon Dioxide

Ceramic grinding media of a size of 0.8-1.0 microns (Norstone Inc., Wyncote, Pa., USA) was added to the 1-liter Dupont high pressure media mill, so that 70% of the grinding chamber was filled with the grinding media (bulk volume). A physical blend of 100 grams USP grade ibuprofen (Spectrum Chemicals) and 2 grams surfactant Sodium lauryl sulfate SLS (Spectrum Chemicals) was added to the grinding chamber.

The mill was sealed and charged with CO₂ at supercritical conditions (SC) (temperature of 37° C. and pressure of 1450 psi). The dispersion was milled at a mill speed of 1750 RPM for 60 minutes.

The milling the mill was purged with SC CO₂ at 800 psi. The ceramic grinding media were retained inside the grinding chamber by a 440 micron grinding media retention screen (Swagelok). The milled product particles were entrained in the purging CO₂ stream and carried to the high pressure filter housing. The product particles were collected on the 400 nm porous metal filter (Norman Filter).

The milled ibuprofen was a white powder with a poor flowability. The mass of the product recovered from the filter was 65 grams. A Malvern Mastersizer 2000 (Malvern Instruments, Worcestershire, UK) was used to measure the size of the ibuprofen particles after collection in the high pressure filter. The median size was 2.6 micron. The 10% cumulative undersize was 1.097 micron. The 90% cumulative undersize was 219 microns due to agglomeration.

### Example 3

### Media Milling of Lactose Crystals in a Pressurized Pharmaceutical Propellant HFC-134a

Ceramic grinding media of a size of 0.8-1.0 microns (Norstone Inc., Wyncote, Pa., USA) was added to the 1-liter Dupont high pressure media mill, so that 70% of the grinding chamber was filled with the grinding media (bulk volume). A physical blend of 50 grams USP grade lactose mono hydrate (Spectrum Chemicals) and 1 wt % surfactant sorbitan monooleate Span85 (Spectrum Chemicals) was added to the grinding chamber.

The mill was charged with liquified pharmaceutical propellant Dymel HFC 134a (Dupont) at a pressure of 1000 psi and a temperature of 21° C. Dymel HFC134a is tetrafluoroethane. The lactose suspension in HFC was milled at a mill speed of 1750 RPM for 60 minutes.

After completion of the milling, the mill was purged with liquefied HFC at 1000 psi using a bladder system. The grinding media were retained inside the grinding chamber by a 440 micron grinding media retention screen (Swagelok). The milled product particles were entrained by the purging HFC stream and discharged through the bottom mill outlet and carried to the high pressure filter housing. The lactose particles were collected on the 400 nm porous metal filter (Norman Filter).

The milled lactose was a white substance with no noticeable discoloration. The mass of the product recovered from the filter was 27 grams. A Malvern Mastersizer 2000 (Malvern Instruments, Worcestershire, UK) was used to measure the size of the lactose particles collected in the high pressure filter. The median particle size was 4.4 microns. The 10% cumulative undersize was 1.059 micron. The 90% cumulative undersize was 553 micron.

### Example 4

### Media Milling of Piroxicam in Supercritical Carbon Dioxide

Ceramic grinding media with a size of 800-1000 microns (Norstone Inc., Wyncote, Pa., USA) was added to the 300 ml Dupont high pressure media mill, so that 70% of the grinding chamber was filled with the grinding media (bulk volume). A physical blend of 20 grams piroxicam (Spectrum Chemicals) was added to the mill chamber.

The mill chamber was charged with CO2 at a temperature of 33° C. and pressure of 1150 psi. The dispersion was milled at a mill speed of 1750 RPM for 120 minutes.

After that the mill chamber was purged with supercritical CO₂ at 800 bar and 25° C. The grinding media were retained inside the grinding chamber by a 440 micron grinding media retention screen (Swagelok). The milled piroxicam particles were entrained by the purging CO₂ stream and carried to the high pressure filter.

The product particles were collected on the 400 nm porous metal filter (Norman Filter). Two collection methods were tested: (1) Depressurization after product collection in the high pressure filter. (2) Depressurization during nozzle dispersion in the high pressure filter.

In both cases the end product produce was a white substance with a good powder flowability. A Malvern Mastersizer 2000 (Malvern Instruments, Worcestershire, UK) was used to measure the size of the lactose particles after collection in the high pressure filter.

The results of the experiments are summarized in Table 2. The yield of the run with the depressurization was 10.7 grams, while in the case of the nozzle dispersion only 2.4 grams were recovered. The particle size of the powder of the nozzle dispersion method was finer, indicating that the nozzle dispersion helped to break down the agglomerates. Results listed in Table 2.However, the surface area measurements (BET) showed that the surface area of the product collected in the filter before depressurization is 11.8 sq meter per gram, while the nozzle dispersed material had a specific surface are of 9.7 sq meter per gram.

TABLE 2
Summary of test results

| | Yield | X10 | X50 | X90 | BET |
|---|---|---|---|---|---|
| | [grams] | [micron] | [micron] | [micron] | [sq. m/g] |
| Test 1 | 10.7 | 3.00 | 5.70 | 10.9 | 11.8 |
| Test 2 | 2.4 | 0.08 | 0.26 | 2.04 | 9.4 |

Test 1: Depressurization of gas after filter.
Test 2: Nozzle dispersion in filter (depressurization of nozzle filter inlet) X90 is the “90% cumulative undersize” of the powder, which means that 90 weight % of the particles in the powder are smaller than that particular size. For example: X90 = 5.5 micron means that 90 wt % of the powder is smaller than 5.5 micron.

### Example 5

### Media Milling of Drug Formulation in Supercritical Carbon Dioxide

Ceramic grinding beads with a size of 800-1000 microns (Norstone Inc., Wyncote, Pa., USA) were added to the 300 ml Dupont high pressure media mill, so that 70% of the grinding chamber was filled with the grinding beads (bulk volume). A mixture of the poorly water-soluble pharmaceutical active phenytoin-diphenylhydantoin (cas# 5741-0) (5 g), and the following inactive ingredients, lactose monohydrate from DMV (14 g), disintegrant ac-di-sol® from FMC polymers (0.8 gr), and sodium lauryl sulphate (cas# 151-21-3) surfactant (0.2 gr) were added to the mill chamber. The grinding chamber was charged with CO₂ at a temperature of 25° C. and pressure of 800 psi. The internal temperature of the grinding chamber was brought to and maintained at 33° C. and 1450 psi during milling. The dispersion was milled at a mill speed of 1750 RPM for 120 minutes.

After that the mill chamber was purged with supercritical CO₂ at 800 psi and 25° C. The grinding beads were retained inside the grinding chamber by a 440 micron grinding media retention screen (available from Swagelok). The co-milled phenytoin formulation was entrained by the purging CO₂ stream and carried to the high pressure collection filter. The product particles were collected on the 400 nanometer porous metal filter (available from Norman Filter).

Two sets of gelatine capsules (size 00) were prepared. Sample 1 is the co-grind phenytoin composition. Sample 2 is the hand mixed mixture of unmilled phenytoin and excipients. Formulations of samples 1 and 2 contain equal amounts of active and excipients. The compositions are listed in Table 3.

Dissolution profiles on the formulations containing the active pharmaceutical phenytoin were measured in a 7.2 phosphate buffer. The USP (U.S. Pharmacopeia) dissolution method was performed by using apparatus 2 as described in chapter 711 of the USP. The vessel volume was 900 mL and the paddle speed was 50 rpm for all the media in which samples were tested. Because the product being tested in this instance was in the form of capsules, USP-type stainless steel sinkers were employed to keep the product from floating when first introduced into the vesssels. Samples were analyzed on a Unicam UV300 spectrophotometer running in Intelliscan mode.

The in-vitro dissolution results are plotted in Table 3. The HPMM cogrind formulation (sample 1) shows a significant increase in the dissolution rate compared to handmixed formulation (sample 2). The concentration in solution of sample 1 levels out at the saturation concentration within 10-20 minutes. Thus, the co-milling resulted in imiproved wetting, water penetration and disintegration of Sample 1.

TABLE 3
Capsule compositions

| | Description | Capsule fill | Weight | |
|---|---|---|---|---|
| Sample 1 | HPMM Co-grind mixture | Co-grind mixture | 200 | mg |
| | of phenytoin (50 mg), | Magnesium stearate | 2 | mg |
| | ac-di-sol (8 mg), SLS (2 | | 202 | mg |
| | mg), and lactose (140 mg) | | | |
| Sample 2 | Handmixed blend of | Phenytoin (neat) | 50 | mg |
| | phenytion, ac-di-sol, | Lactose | 140 | mg |
| | sis and lactose | Ac-di-sol | 8 | mg |
| | | SLS | 2 | mg |
| | | Magnesium stearate | 2 | mg |
| | | | 202 | mg |

1. A high pressure mill system comprising:
a.) a pressure delivery device;
b.) a high pressure media mill fluidly connected to said pressure delivery device comprising a housing comprising a top, a body, and a floor, thereby defining a grinding chamber; an agitator contained within said grinding chamber, a motor in rotational communication with said agitator and an amount of grinding media contained within the grinding chamber; and
c.) a means for product collection fluidly connected to said media mill.

2. The system according to claim 1, wherein the pressure delivery device is bladder accumulator or pressure regulator

3. The system according to claim 1, wherein the housing further comprises at least one discharge port, and at least one charging port.

4. The system according to claim 3, wherein the at least one discharge port is in the floor of the housing.

5. The system according to claim 3, wherein a removable plunger having a removable retention screen is inserted into the at least one discharge port.

6. The system according to claim 5, wherein the retention screen has a mesh size that is about ⅓ the size of a grinding media.

7. The system according to claim 6, wherein the mesh size is about 440 micrometers.

8. The system according to claim 1, wherein the housing further comprises a second cavity.

9. The system according to claim 8, wherein a drive shaft passes through the second cavity, thereby connecting the agitator with the motor.

10. The system according to claim 1, wherein the housing is hermetically sealed.

11. The system according to claim 1, wherein the pressure delivery device and the media mill are fluidly connected using a pipe, conduit or tubing.

12. The system according to claim 1, wherein the agitator comprises at least one agitation element.

13. The system according to claim 12, wherein the agitator further comprises a sweeper blade.

14. The system according to claim 12, wherein the at least one agitation element is a pin, disc or annulus.

15. The system according to claim 1, wherein the motor comprises an electric motor, direct drive motor, magnetic drive motor.

16. The system according to claim 1, wherein the grinding media comprises a material comprising at least one of nylon materials, polymeric materials, ceramic materials, sand, metals, zirconium silicate, zirconium oxide, yttrium oxide, glass, alumina, titanium, and silica.

17. The system according to claim 16, wherein the grinding media comprises polymeric grinding media.

18. The system according to claim 1, wherein the grinding media are spherical, nonspherical or combinations thereof.

19. The system according to claim 1, wherein the grinding media range from about 12 mm to about 10 microns in size.

20. The system according to claim 1, wherein the grinding media range from about 5000 microns to about 10 microns in size.

21. The system according to claim 1, wherein the media mill and the means for separation are fluidly connected using a pipe, conduit or tubing.

22. The system according to claim 1, wherein the means for separation is a pressurized filtration system or flash-drying system.

23. A process for milling a product under high pressure comprising:
(i) evacuating the high pressure media mill system according to claim 1 to produce a vacuum;
(ii) charging the media mill with an amount of grinding media, a product and/or a fluid and/or a co-solvent;
(iii) pressurizing the media mill system with the fluid;
(iv) operating the media mill to reduce the particle size of the product; and
(v) separating the product from the fluid.

24. The process according to claim 23, wherein said process is continuous.

25. The process according to claim 23, wherein the process is semi-continuous.

26. The process according to claim 23, wherein the process is a batch process.

27. The process according to claim 23, wherein the fluid is a gas, a pressurized gas, a liquefied gas, a supercritical fluid, a subcritical fluid and combinations thereof.

28. The process according to claim 27, wherein the fluid is a supercritical fluid.

29. The process according to claim 28, wherein the supercritical fluid is carbon dioxide.

30. The process according to claim 23 wherein the amount of grinding media occupies from about 0% to about 95% of the grinding chamber.

31. The process according to claim 30 wherein the amount of grinding media occupies from about 50% to about 95% of the grinding chamber.

32. The process according to claim 31 wherein the amount of grinding media occupies from about 70% to about 80% of the grinding chamber.

33. The process according to claim 32 wherein the amount of grinding media occupies about 80% of the grinding chamber.

34. The process according to claim 23, where the product comprises a bioactive comprising a pharmaceutical, an agrochemical, a diagnostic agent, a nutraceutical, a food or food ingredient, metals, inactive agent and combinations thereof.

35. The process according to claim 34, wherein the pharmaceutical substance comprises anabolic steroids, analeptics, analgesics, anesthetics, antacids, anti-arrthymics, anti-asthmatics, antibiotics, anti-cariogenics, anticoagulants, anticolonergics, anticonvulsants, antidepressants, antidiabetics, antidiarrheals, anti-emetics, anti-epileptics, antifungals, antihelmintics, antihemorrhoidals, antihistamines, antihormones, antihypertensives, anti-hypotensives, anti-inflammatories, antimuscarinics, antimycotics, antineoplastics, anti-obesity drugs, antiplaque agents, antiprotozoals, antipsychotics, antiseptics, anti-spasmotics, anti-thrombics, antitussives, antivirals, anxiolytics, astringents, beta-adrenergic receptor blocking drugs, bile acids, breath fresheners, bronchospasmolytic drugs, bronchodilators, calcium channel blockers, cardiac glycosides, contraceptives, corticosteriods, decongestants, diagnostics, digestives, diuretics, dopaminergics, electrolytes, emetics, expectorants, haemostatic drugs, hormones, hormone replacement therapy drugs, hypnotics, hypoglycemic drugs, immunosuppressants, impotence drugs, laxatives, lipid regulators, mucolytics, muscle relaxants, non-steroidal anti-inflammatories, nutraceuticals, pain relievers, parasympathicolytics, parasympathicomimetics, prostagladins, psychostimulants, psychotropics, sedatives, sex steroids, spasmolytics, steroids, stimulants, sulfonamides, sympathicolytics, sympathicomimetics, sympathomimetics, thyreomimetics, thyreostatic drugs, vasodialators, vitamins, xanthines, and mixtures thereof.

36. The process according to claim 34, wherein the diagnostic agent comprises ethyl-3,5-bisacetoamido-2,4,6-triiodobenzoate, ethyl(3,5-bis(acetylamino)-2,4,6-triiodobenzoyloxy)acetate, ethyl-2-(bis(acetylamino)-2,4,6-triiodobenzoyloxy)butyrate, 6-ethoxy-6-oxohexyl-3,5-bis(acetylamino)-2,4,6-triiodobenzoate and mixtures thereof.

37. The process according to claim 34, wherein the nutraceutical comprises dietary supplements, herbal remedies, and functional foods.

38. The process according to claim 34, wherein the agrochemical comprises an insecticidal compound, an agricultural agent, a germicide, a plant growth regulating agent, a herbicide and mixtures thereof.

39. The process according to claim 34, wherein the herbicide comprises photosynthesis inhibitors, pigment inhibitors growth inhibitors, amino acid synthesis, lipid biosynthesis inhibitors, cell wall biosynthesis inhibitors, and rapid cell membrane disruptors, and mixtures thereof.

40. The process according to claim 34, wherein the food or food ingredient comprises soy, carbohydrates, polysaccharides, oligosaccharides, disaccharides, monosaccharides, proteins, peptides, amino acids, lipids, fatty acids, phytochemicals, vitamins, minerals, salts, food colors, enzymes, sweeteners, anti-caking agents, thickeners, emulsifiers, stabilizers, anti-microbial agents, antioxidants, and mixtures thereof.

41. The process according to claim 34, wherein the metal comprises silver, gold, platinum, copper, tin, iron, lead, magnesium, titanium, mixtures thereof.

42. The process according to claim 34, wherein the inactive agent is an excipient, surfactant, dispersant, polymer, filler, flow-aid, binder, coating agent, colorant, emulsifier, stabilizer and mixtures thereof.

43. The process according to claim 23, wherein the co-solvent comprises water, ethanol, isopropyl alcohol, polyethylene glycol, propylene glycol, dipropylene glycol and mixtures thereof.

44. A pharmaceutical milled according to the process of claim 23.

45. A nutraceutical milled according to the process of claim 23.

46. A agrochemical milled according to the process of claim 23.

47. A diagnostic agent milled according to the process of claim 23.

48. A high pressure media mill fluidly connected to said pressure delivery device comprising a housing comprising a top, a body, and a floor, thereby defining a grinding chamber; an agitator contained within said grinding chamber, a motor in rotational communication with said agitator and an amount of grinding media contained within the grinding chamber.

49. A plunger comprising a first cylindrical member having an first end and a second end; a slidable second cylindrical member having an inner end comprising a plug having a removable retention screen mounted, wherein the second cylindrical member is nested within the first cylindrical member where the inner end is inserted into a discharge port of the media mill according to claim 1.
